(19) United States
(12) Patent Application Publication
(10) Pub. No.: US 2009/0298007 A1
(43) Pub. Date: Dec. 3, 2009

(54) Double bite impression tray for making dental impressions

(76) Inventor: Jose E. Walter, (US)

Correspondence Address: Hendricks and Associates, P.O. Box 2509, Fairfax, VA, 22031, US

(21) Appl. No.: 12/155,040

(22) Filed: May 29, 2008

(51) Int. Cl. A61C 9/00

(52) U.S. Cl. 433/38

(57) ABSTRACT

Dental impression trays having a peripheral buccal supporting wall, a second wall which is parallel to the peripheral supporting wall with connecting means between the first supporting wall and the second wall. A partition is attached to the second wall to create a superior receptive cavity or compartment and an inferior receptive cavity or compartment in the impression tray. The trays provide needed stability when making impressions of both upper and lower teeth and jaw simultaneously.

### FIELD AND BACKGROUND OF THE INVENTION

This invention relates to trays for making dental impressions of the teeth. The impression tray holds a temporarily viscous material which is pressed against the teeth. Within a short period of time the material becomes sufficiently firm to hold an impression of the teeth when the tray with the impression material is removed from the mouth. The dental laboratory uses the impression to make models of the teeth of the patient. Usually the impression trays consist of a base and of at least two side walls which together surround the area from which the impression is to be taken. The impression material is placed in the tray and the material in the tray is then placed firmly against the teeth and/or jaw for imposition of the impression.

It is sometimes desirable to have an impression of both upper and lower teeth taken at one time. This makes it possible to more clearly register the relationship of the teeth as they come together during biting. A triple tray is used to simultaneously register the upper and lower bite. Most triple trays currently on the market are molded as a single piece from thermoplastic compound. In some instances, this plastic may be distorted during the taking of the impression by the bite pressure. Any distortion of impression material will result in an ill-fitting prosthesis.

Impressions are often taken when preparing an implant after dental implants have healed into the underlying bone structures of the mandible or maxilla and the soft gum tissue has healed. A full set of upper and lower impressions (negative casts) of the mouth are made using individual full or partial arch upper and lower trays. Positive casts of these impressions are mounted upon a mechanical articulator that mimics the motion of the jaws. A separate bite registration cast is also made. The positive casts can then be manipulated to accurately replicate the structures in the mouth. These positive casts are tested against the bite registration cast.

U.S. Pat. No. 6,913,461 to Gittleman teaches a double bite tray for taking impressions of teeth on one side of the jaw. The tray has a mesh separating the impression material which encounters the upper teeth and the impression material which will take the impression of the teeth of the lower jaw. The impression tray is equipped with several hinges which are rendered inflexible by a light-cured compound. The impression trays of Gittleman take impressions of only a part of the jaw (right or left). (While trays of the instant invention can, indeed, be made for use in taking impressions of part of the teeth, it is sometimes most useful to have double impressions of the full teeth on each jaw.) The trays of Gittleman also require complex hinge means which can be rendered inflexible by use of a light cured compound when the hinge is exposed to a light of appropriate frequency.

U.S. Pat. No. 7,021,929 to DiMarino, et al., teaches an impression tray which will take a double impression of a full bite. The impression tray of DiMarino has an inner wall and an outer wall, each of which has projections into the space into which the impression material is placed to keep the impression material from slipping and moving. The tray presents two problems. First, it is sometimes difficult to extract the solidified impression material from the tray. Furthermore, the projections are such that they can distort the impression because of pressure in the area where the teeth impact the impression material.

Several patents disclose impression trays for obtaining an impression of either the upper or lower jaw, but not an impression of both at one time. U.S. Pat. No. 6,468,078 to Guillaume, et al.; U.S. Pat. No. 6,786,722 to Craig, et al.; U.S. Pat. No. 6,447,292 to Champagne, et al. and U.S. Pat. No. 6,247,925 to Schreinemakers all teach impression trays for taking impression of the upper and/or lower jaw separately.

### SUMMARY OF THE INVENTION

The dental impression trays of the invention have a peripheral buccal supporting wall, a second wall which is parallel to the peripheral supporting wall with connecting means between the first supporting wall and the second wall. A partition is attached to the second wall to create a superior receptive cavity or compartment and an inferior receptive cavity or compartment in the impression tray. The impression tray has a handle attached to the peripheral supporting wall. In a preferred embodiment, the handle has, as a part thereof, a rib which adds stability to the tray. The webbing that transversely separates the space within the wall into an superior compartment or upper cavity holds impression material which will contact the upper teeth and/or jaw and the inferior compartment or lower cavity which is designed to hold impression material which will contact the lower teeth and/or jaw. There is a second crescent shaped wall (preferably a double wall) extending into the upper and lower compartments at a position distal from the handle which functions as a second retaining wall in both the upper and lower cavity and inhibits transfer of impression material from going down the throat of the patient.

### BRIEF DESCRIPTION OF THE DRAWINGS

FIG. 1 shows a perspective view of the of the tray showing particularly the handle and support means for the outer or buccal retentive wall.

FIG. 2 shows a perspective view of the tray showing the compartment which holds the impression material that will take the impression of the upper teeth from an aspect of the tray showing particularly the face of the peripheral retentive wall which interacts with the impression material, showing particularly features of the tray responsible for flexibility of the tray and means for holding the impression material.

FIG. 3 shows a perspective view of the tray exposing the compartment which holds the impression material for taking an impression of the lower teeth with particular attention to the wall running parallel to the outer retentive buccal wall.

FIG. 4 shows a cross section of the wall structure near the peripheral or buccal retention wall and adjoining structures.

FIG. 5 shows a side view of the tray with the handle and support means and the exterior of the buccal retentive wall.

FIG. 6 shows planar view of the articulator showing the attachment areas between the exterior buccal wall and the adjoining interior wall which is parallel to the outer wall.

FIG. 7 shows a detail of the exterior buccal wall and the wall running parallel thereto, indicating the connecting means and the slots which allow impression material to flow between the upper and lower compartments which hold impression material for obtaining impressions of the upper and of the lower teeth.

### DETAILED DESCRIPTION OF THE INVENTION

The making of dental impressions presents several problems for the dental practitioner. If the impression of the upper and lower teeth/jaw are taken separately, the impression may not give optimal information regarding bite. The trays of the invention have a first buccal supporting wall, a second wall which is parallel to the first supporting wall with interspersed connecting means between the first supporting wall and the second well. There are open spaces between the connecting means connecting the peripheral wall with the second wall running parallel to the first wall. There is stretches across the second wall a partition, usually a mesh, which divides the space horizontally to create a superior receptive cavity or compartment and an inferior receptive cavity or compartment in the impression tray. The partition may be made of any material which will be sufficiently strong to hold the impression material. Preferred are synthetic fabrics such as polyester or nylon. While the partition may be woven or non-woven, it is preferred that the material be a mesh which will hold the impression material more firmly so that it does not slip and slide freely.

The trays of the invention make it possible to make an accurate, simultaneous impression of both the upper and lower teeth in the alignment usual when biting. Both the upper or superior compartment and the lower or inferior compartment of the tray are filled with impression material. The tray is placed in the mouth so that the impression material in the superior or upper cavity or compartment contacts the upper teeth and/or jaw, and the impression material in the inferior or lower cavity or compartment contacts the lower teeth or jaw. The mesh partition is then oriented between the mating occlusal surfaces of the teeth. In this manner, a set of aligned upper and lower impressions registering an accurate bite registration is made.

Impression materials usually used in dentistry can be used. For example, elastomeric impression materials such as polyvinylsiloxane or polyether, are appropriate because of their dimensionally stability and, before hardening, their flexibility which allows removal of the impression material from the teeth when the material has attained sufficient structural integrity to retain its shape. If an impression from a single area of the teeth/jaw is to be made, a half-arch triple tray can be used. The trays may be made of any plastic that is sufficiently firm to provide support and avoid distortion of the final product. Hard rubber would also be acceptable.

### DEFINITIONS

“Buccal Wall” is the wall that touches the buccal lining of the cheek when then the impression is being taken.

“Superior compartment or cavity” is the cavity into which impression material will be placed that will be in contact with the upper teeth or jaw when making the impression. (“Teeth or jaw” is used in this description since it is essential that an impression show where teeth are missing, including those instances where all or most teeth are missing.)

“Inferior compartment or cavity” is the cavity into which impression material will be placed that will contact the lower teeth or jaw when making the impression.

“Slots” applies to grooves in the side of a wall. They do not extend through the wall. They are undercut to provide extra means for the impression fluid to flow between the superior cavity and the inferior cavity.

“Slats” applies to the narrow projections that are between the grooves.

“Slits” applies to openings in the wall through which excess impression material can escape when under pressure from biting.

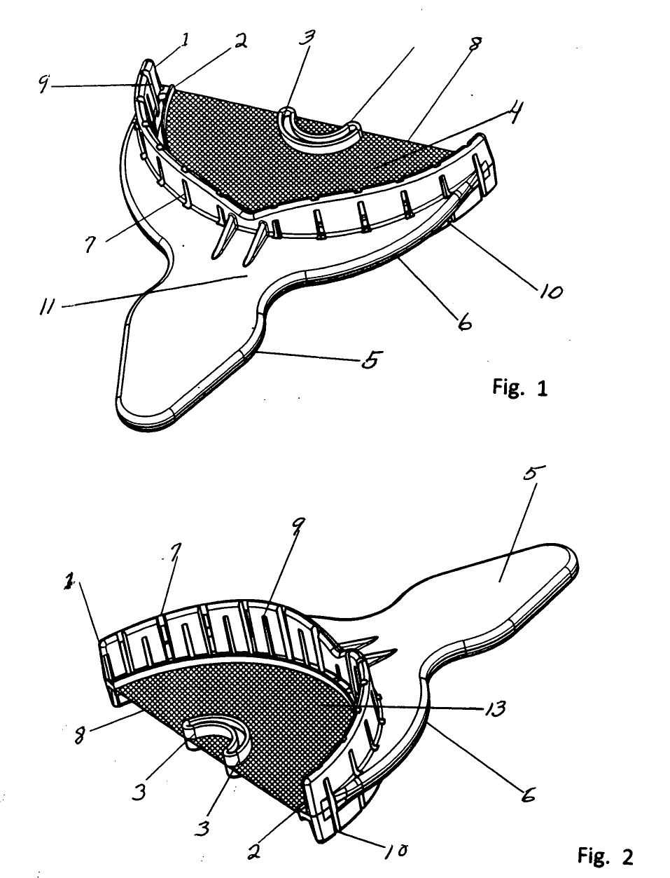

Referring to the figures, FIG. 1 shows a perspective view of the of the tray (11) showing particularly the upper or superior cavity or compartment (4) There is a first retentive wall (1), a second wall (2) which runs parallel to the first retentive wall and an interior retaining wall structure (3) which, in the figure, is a double walled structure, which is a preferred embodiment. A mesh (8) which is stretched horizontally across the second wall (2) acts as a partition between the upper or superior cavity or compartment and the inferior or lower cavity or compartment (not seen on this FIG. 1). The handle (5) and a supporting rib (6) provide added stability to the buccal or outer retentive wall (1). There are grooves or slots (9) in the inner surface of the peripheral buccal wall which do not extend through the wall, but are undercut to result in protruding slats. The openings resulting from the grooves cause impression material to pass between the upper and lower compartments or cavities to provide stability to the impressions. Additionally there are openings (7) which extend through the buccal wall. There may be under cuts (10) at the edge of the wall to provide added flexibility.

FIG. 2 provides a better view of the interior of the compartment which holds the impression material which will take the impression of the upper teeth showing particularly the face of the peripheral wall which interacts with the impression material and showing particularly features of the tray responsible for flexibility of the tray and means for holding the impression material firmly in place. The grooves (9) and the openings (7) which extend through the wall are seen.

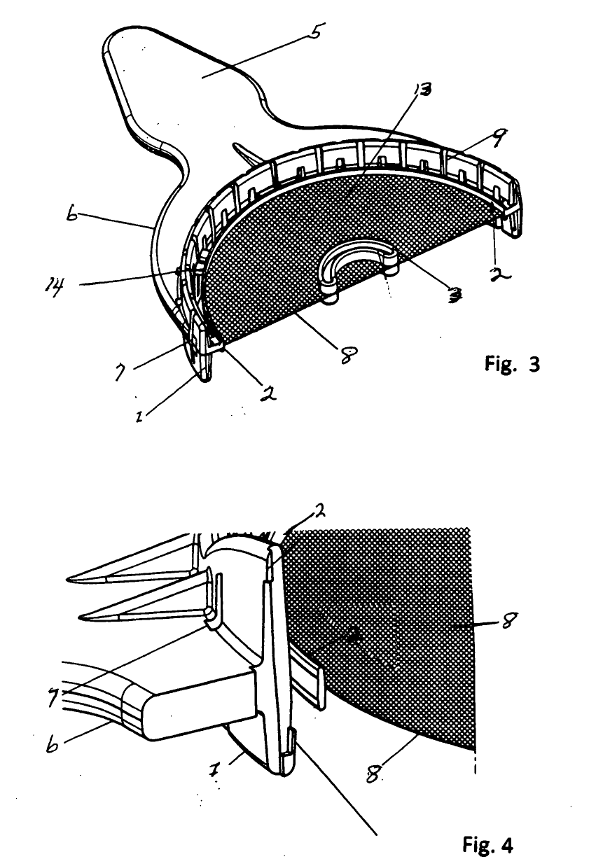

FIG. 3 is a perspective view of the tray of FIG. 1 inverted to show the inferior compartment or cavity (13) that holds the impression material for taking an impression of the lower teeth when in use. This figure draws particular attention to a second wall (2) within the exterior wall which runs parallel to the peripheral retentive wall (1). In this figure it is possible to identify some of the connecting structures (14) that connect the peripheral retentive wall (1) to the second supporting wall (2).

FIG. 4 provides a view of a cross section of the wall structure showing the peripheral buccal retention wall (1) the second, inner supporting wall (2) to which the mesh partition (8) is attached. Also clearly seen are the openings (7) which extend through the wall as seen from the exterior of the peripheral buccal wall.

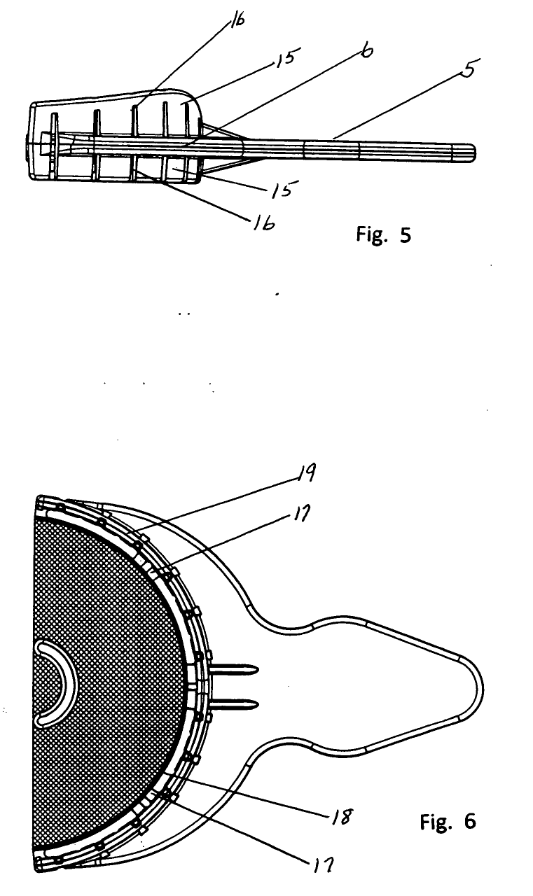

FIG. 5 shows a side view of the tray from the exterior with the handle (5) and supporting rib (6). The exterior of the buccal retentive wall (15) and the openings (16) which extend from the upper cavity or compartment to the lower cavity or compartment can be seen.

FIG. 6 provides a planar view of the articulator whether seen from the aspect of either superior or inferior showing the attachment areas (connection means) (17) between the exterior peripheral buccal (19) wall and the interior wall (18) which is immediately parallel to said peripheral wall and is connected to the peripheral wall trough the connection means.

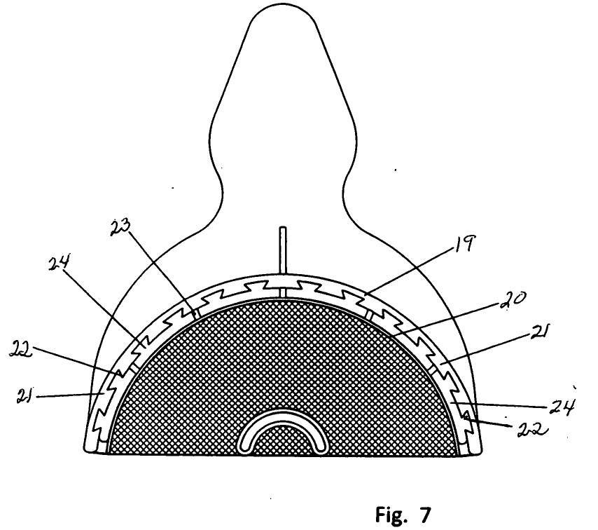

FIG. 7 provides a detailed view of the exterior buccal wall (19) and the parallel wall (20) holding the partition material, indicating the connecting means (23) and the open space (24) occasioned by the repeating grooves which allows impression material to flow between the superior and inferior compartments and which stabilize the molded impression material. The area between the grooves appear as slats (21). In the preferred embodiment the grooves are undercut (22) to provide additional stability to the finished impression.

What we claim is:

1: An impression tray having a peripheral buccal supporting wall, a second wall which is parallel to said first supporting wall with connection means between said first supporting wall and said second wall parallel thereto, and a partition which is attached to said second wall to create a superior receptive cavity or compartment and an inferior receptive cavity or compartment for holding impression material in said impression tray and wherein said impression tray has a handle attached to said peripheral supporting wall.

2: The impression tray of claim 1 wherein there are, additionally openings in the peripheral supporting wall which extend through the wall in such a manner that material within the wall can be extruded through the wall.

3: The impression tray of claim 1 wherein, as part of the handle, there is a supporting rib which surrounds the handle and becomes a part of the supporting structure of said peripheral wall.

4: The impression tray of claim 1 wherein the interior aspect of the peripheral wall there are grooves which permit impression material to move between superior and inferior receptive compartments.

5. The impression tray of claim 1 wherein there is an interior retaining wall structure distal to the handle adherent to a partition which creates the superior receptive cavity into inferior cavity, said retaining wall extending into both said superior cavity and inferior cavity.

6: The impression tray of claim 1 wherein there are, additionally openings in the peripheral supporting wall which extend through the wall in such a manner that material within the cavity can be extruded through the wall and wherein, as part of the handle, there is a supporting rib which surrounds the handle and becomes a part of the supporting structure of said peripheral wall.

7: The impression tray of claim 1 wherein the interior aspect of the peripheral wall there are grooves which permit impression material to move between superior and inferior receptive compartments and wherein, additionally, there is an interior retaining wall structure distal to the handle adherent to a partition which creates the superior receptive cavity and inferior cavity, said retaining wall extending into both said superior cavity and inferior cavity.

8: The impression tray of claim 7 wherein the tray is made of plastic.

9: The impression tray of claim 1 wherein the tray is made of plastic.

10. The impression tray of claim 1 wherein the partition material is a synthetic mesh.

11. The impression tray of claim 7 wherein the partition material is a synthetic mesh fabric.
